(19) United States
(12) Patent Application Publication
(10) Pub. No.: US 2014/0059161 A1
(43) Pub. Date: Feb. 27, 2014

(54) USER VIRTUALIZATION INITIALIZATION

(71) Applicant: Joseph SAIB, Santa Clara, CA (US)

(72) Inventor: Joseph SAIB, Santa Clara, CA (US)

(73) Assignee: APPSENSE LIMITED, Warrington (GB)

(21) Appl. No.: 13/592,571

(22) Filed: Aug. 23, 2012

(51) Int. Cl. G06F 15/16

(52) U.S. Cl. 709/217

(57) ABSTRACT

Systems and methods are described for providing a user virtualization (UV) system. A non-transitory computer readable medium includes executable instructions that are operable to, when executed by a computing device, cause the computing device to: acquire an input related to user identification (ID) information from a non-contact user ID input device, determine a user ID based on the acquired input, transmit the user ID to a UV control server over a network, receive UV information corresponding to the user ID from the UV control server, and apply the received UV information to a UV client device.

### BACKGROUND

User virtualization (UV) has traditionally been limited to personal computers (PC), e.g., computers running Windows 7 operating system. And user virtualization on PCs has typically relied on conventional input mechanisms to initialize user virtualization (e.g., a user types in a login ID and password via a keyboard connected to a PC). Corporate computing has been going through significant transformations. While traditional personal computers (PCs) (e.g., desktop computer and laptop computer, etc.) remain the predominant work platforms in many organizations, variety of computing devices (e.g., smartphones, tablet computer, and other portable devices, etc.) have begun to play more prominent role in corporate computing. With the ever-growing prevalence of non-traditional computing devices (e.g., smartphones, tablets, and other portable devices, etc.), more effective and/or efficient mechanisms of initializing user virtualization are desired.

### SUMMARY

In accordance with the disclosed subject matter, systems and methods are described for providing user virtualization systems and methods.

Disclosed subject matter includes, in one aspect, a non-transitory computer readable medium which includes executable instructions that are operable to, when executed by a computing device, cause the computing device to: acquire an input related to user identification (ID) information from a non-contact user ID input device, determine a user ID based on the acquired input, transmit the user ID to a UV control server over a network, receive UV information corresponding to the user ID from the UV control server, and apply the received UV information to a UV client device.

In some embodiments, the executable instructions are further operable to cause the computing device to acquire the input related to the user ID information from a Quick Reference (QR) code reader.

In some embodiments, the executable instructions are further operable to cause the computing device to acquire the input related to the user ID information from a Radio Frequency Identification (RFID) receiver.

In some embodiments, the executable instructions are further operable to cause the computing device to acquire the input related to the user ID information from a Near Field Communication (NFC) receiver.

In some embodiments, the executable instructions are further operable to cause the computing device to acquire the input related to the user ID information from a facial recognition detector.

In some embodiments, the executable instructions are further operable to cause the computing device to acquire the input related to the user ID information from a voice recognition detector.

In some embodiments, the executable instructions are further operable to cause the computing device to monitor customization of UV information and uploading the customization of UV information to the UV control server.

Disclosed subject matter includes, in another aspect, a user virtualization (UV) agent which includes a host interface configured to communicate with a UV client device associated with the UV agent, a UV control server interface configured to communicate with a UV control server over a network, a user identification (ID) input interface configured to acquire an input related to user ID information from a non-contact user ID input device and determine a corresponding user ID using the acquired input, and a UV logic module configured to interpret UV information received from the UV control server based on the user ID and apply the UV information to the UV client device.

In some embodiments, the non-contact user ID input device includes a Quick Reference (QR) code reader.

In some embodiments, the non-contact user ID input device includes a Radio Frequency Identification (RFID) receiver.

In some embodiments, the non-contact user ID input device includes a Near Field Communication (NFC) receiver.

In some embodiments, the non-contact user ID input device includes a facial recognition detector.

In some embodiments, the non-contact user ID input device includes a voice recognition detector.

In some embodiments, the UV logic module is further configured to monitor customization of UV information and upload the customization of UV information to the UV control server.

Various embodiments of the subject matter disclosed herein can provide one or more of the following capabilities. A user virtualization (UV) system can present more efficient and/or effective mechanisms of initializing user virtualization. The user virtualization initialization mechanisms disclosed herein can provide the necessary information (e.g., a user ID in a UV system) on non-traditional computing devices (e.g., smartphones, tablet computers, and other portable devices, etc.). A user virtualization system can be initialized without the need of conventional input mechanisms (e.g., keyboard and mouse of a PC).

These and other capabilities of the invention, along with the invention itself, will be more fully understood after a review of the following figures, detailed description, and claims.

### BRIEF DESCRIPTION OF THE DRAWINGS

FIG. 1 illustrates a diagram of an exemplary networked communication system.

FIG. 2 illustrates a block diagram of an exemplary User Virtualization (UV) system.

FIG. 3 illustrates a block diagram of an exemplary UV agent in an UV system.

FIG. 4 illustrates an exemplary UV control table in an UV system.

FIG. 5 illustrates an exemplary operation of an UV system.

FIG. 6 illustrates a block diagram of an exemplary UV client device in a UV system.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are only examples, and that it is contemplated that there are other systems and methods that are within the scope of the disclosed subject matter.

Application virtualization generally refers to software technologies that improve portability, manageability and compatibility of applications by encapsulating them from the underlying operating system on which they are executed. Desktop virtualization (sometimes called client virtualization) generally refers to technologies that separate a personal computer desktop environment from a physical machine, e.g., using the client-server model of computing. User virtualization (UV) generally refers to the independent management of all aspects of the user on the desktop environment. User virtualization solutions can provide consistent and seamless working environments across a range of application delivery mechanisms.

Embodiments of the disclosed subject matter provide techniques for initializing user virtualization. A user virtualization (UV) system can present more efficient and/or effective mechanisms of initializing user virtualization. These mechanisms can be non-contact, as opposed to conventional contact-based mechanisms (e.g., keyboard and mouse). Some examples include: scanning a Quick Reference (QR) code using a camera (or other machine vision technique) to retrieve a user ID, detecting signal from a Radio Frequency Identification (RFID) chip to determine a user ID, sampling a user's voice to identify the user (and her user ID), and capturing a user's facial features to identify the user and (her user ID), etc. These non-conventional mechanisms can be more effective and/or efficient to initialize user virtualization on non-traditional computing devices (e.g., smartphones, tablet computers, and other portable/mobile devices, etc.).

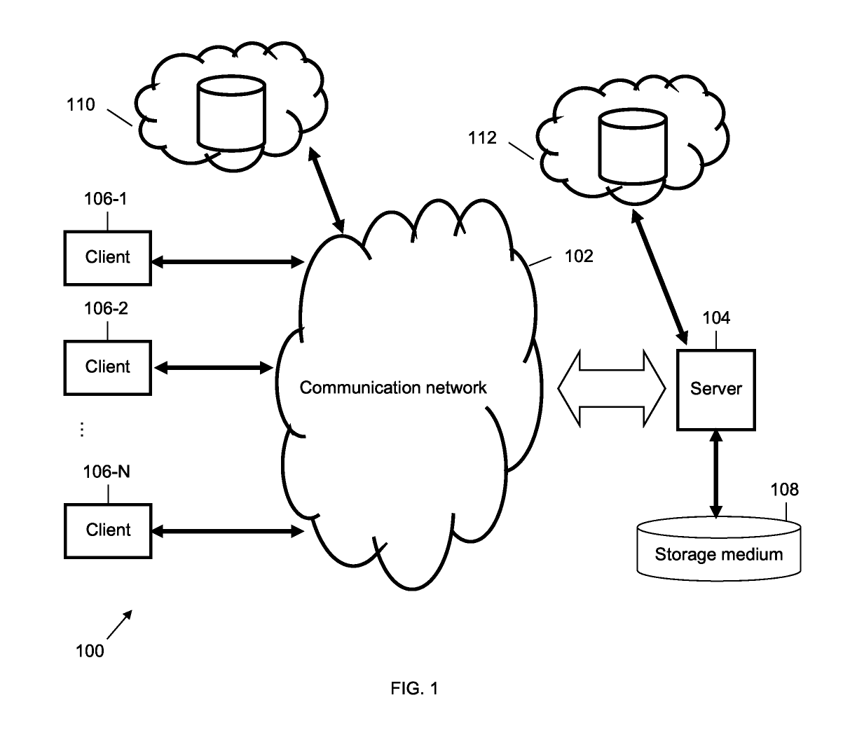

The disclosed subject matter can be implemented in a networked computing system. FIG. 1 illustrates a diagram of an exemplary networked communication arrangement 100 in accordance with an embodiment of the disclosed subject matter. The networked communication arrangement 100 can include a communication network 102, a server 104, and at least one client 106 (e.g., client 106-1, 106-2, . . . 106-N), a physical storage medium 108, and a cloud storage 110 and 112.

Each client 106 can communicate with the server 104 to send data to, and receive data from, the server 104 across the communication network 102. Each client 106 can be directly coupled to the server 104; alternatively, each client 106 can be connected to server 104 via any other suitable device, communication network, or combination thereof. For example, each client 106 can be coupled to the server 104 via one or more routers, switches, access points, and/or communication network (as described below in connection with communication network 102). A client 106 can include, for example, a desktop computer, a mobile computer, a tablet computer, a cellular device, a smartphone, or any computing systems that are capable of performing computation.

Server 104 can be coupled to at least one physical storage medium 108, which is configured to store data for the server 104. Preferably, any client 106 can store data in, and access data from, the physical storage medium 108 via the server 104. FIG. 1 shows the server 104 and the physical storage medium 108 as separate components; however, the server 104 and physical storage medium 108 can be combined together. FIG. 1 also shows the server 104 as a single server; however, server 104 can include more than one server. FIG. 1 shows the physical storage medium 108 as a single physical storage medium; however, physical storage medium 108 can include more than one physical storage medium. The physical storage medium 108 can be located in the same physical location as the server 104, at a remote location, or any other suitable location or combination of locations.

FIG. 1 shows two embodiments of a cloud storage 110 and 112. Cloud storage 110 and/or 112 can store data from physical storage medium 108 with the same restrictions, security measures, authentication measures, policies, and other features associated with the physical storage medium 108. FIG. 1 shows the cloud storage 112 separate from the communication network 102; however, cloud storage 112 can be part of communication network 102 or another communication network. The server 104 can use only cloud storage 110, only cloud storage 112, or both cloud storages 110 and 112. While, FIG. 1 shows one cloud storage 110 and one cloud storage 112, more than one cloud storage 110 and/or more than one cloud storage 112 or any suitable combination thereof can be used.

The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 1 shows the network 102 as a single network; however, the network 102 can include multiple interconnected networks listed above.

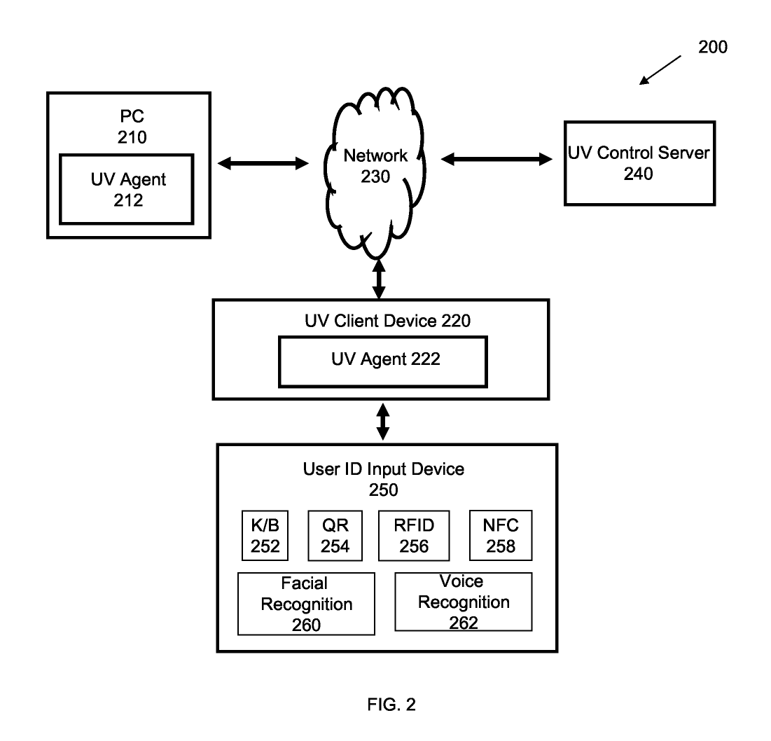

FIG. 2 illustrates a block diagram of a User Virtualization (UV) system 200 in accordance with certain embodiments of the disclosed subject matter. The UV system 200 can include one or more personal computer (PC) 210, one or more other UV client device 220, a network 230, and a UV control server 240. The PC 210, the UV client device 220, and the UV control server 240 can be directly or indirectly coupled to the network 230 and communicate among each other via the network 230, which can be wired, wireless, or a combination of both.

The PC 210 can be any desktop or laptop computers running with one or more operating systems (e.g., Windows 7, Mac OS X, Linux, etc.). The UV client device 220, like each client 106 illustrated in FIG. 1, can include a desktop computer, a mobile computer, a tablet computer, a cellular device, a smartphone, or any computing systems that are capable of performing computation. The UV control server 240 can also include a desktop computer, a mobile computer, a tablet computer, a cellular device, a smartphone, or any computing systems that are capable of performing computation. Although FIG. 2 shows the UV control server 240 as a single server, the UV control server 240 can include more than one physical and/or logical servers. The network 230, like the communication network 102 illustrated in FIG. 1, can include the Internet, a cellular network, a telephone network, a computer network, a packet switching network, a line switching network, a local area network (LAN), a wide area network (WAN), a global area network, a corporate network, an intranet, a virtual network, or any number of private networks currently referred to as an Intranet, and/or any other network or combination of networks that can accommodate data communication. Such networks can be implemented with any number of hardware and software components, transmission media and network protocols. FIG. 2 shows the network 230 as a single network; however, the network 230 can include multiple interconnected networks listed above.

Each PC 210 or UV client device 220 can include a UV agent 212 or 222. The UV agent 212 or 222 can be embedded inside the PC 210 or UV client device 220 as a software module, a hardware component, or a combination of both. Alternatively, the UV agent 212 or 222 can also be separate from but coupled to the PC 210 or UV client device 220. The PC 210 or UV client device 220 can communicate with the UV control server 240 directly or via its UV agent 212 or 222.

Each user of the UV system can have a corresponding unique User ID. The unique User ID can be, for example, assigned by an administrator of the UV system or randomly generated by the UV system. The UV client device 220 can be embedded with or coupled to a User ID Input Device 250. A user of the UV system can input her User ID through the User ID Input Device 250. The User ID Input Device 250 can include any conventional input devices. These conventional input devices can include contact input devices, such as keyboard (KB) 252 or mouse. A user of the UV system can enter her User ID information (e.g., login name) via the KB 252 into the UV client device 220 or the UV agent 222. Alternatively, a user of the UV system can input other identifying information to the User ID Input Device 250. The other identifying information can then be linked to the unique User ID in the UV system 200. The User ID Input Device 250 can include non-conventional input devices, such as a fingerprint reader. The non-conventional input devices can include non-contact input devices. Some examples of non-contact input devices include: a Quick Reference (QR) code reader 254, a Radio Frequency Identification (RFID) receiver 256, a Near Field Communication (NFC) receiver 258, a facial recognition detector 260, a voice recognition detector 262, a machine vision module, etc.

In one example, a smartphone can be a UV client device 220 in a UV system 200. The smartphone 220 can include a hardware component, a software component (e.g., a smartphone application), or a combination of both, which serves as its UV agent 222. The smartphone 220 can also include a QR code reader (e.g., a built-in camera on the smartphone coupled with a QR code application) as its User ID input device 250. A QR code can contain the User ID information itself or contain other identifying information which can be linked to the User ID. When the smartphone 220 scans a QR code containing the User ID itself using the QR code reader, the User ID can be entered into the smartphone 220 and its UV agent 222. Alternatively, the identifying information stored in the QR code can be retrieved by the smartphone 220, which can then link the identifying information to the unique User ID. In some embodiments, the smartphone 220 can contain the necessary information (e.g., a database) locally to support a lookup operation to link the identifying information to the User ID. In other embodiments, the lookup operation is performed remotely (e.g., on the UV control server 240). For example, the smartphone 220 can send the retrieved identifying information to the UV control server 240 via the network 230. The UV control server 240 can perform a lookup (e.g., at a database or a LDAP directory) and locate the corresponding User ID. Optionally, once the User ID is identified, the UV control server 240 can send the User ID back to the smartphone 220.

In another example, a tablet device can be a UV client device 220 in a UV system 200. The tablet device 220 can include a hardware component, a software component (e.g., a tablet device application), or a combination of both, which serves as a UV agent 222. The tablet device 220 can also include a voice recognition detector (e.g., a built-in microphone on the tablet device coupled with a voice recognition application) as its User ID input device 250. A user's voice can uniquely identify the user and thus can be linked to her User ID. When the tablet device 220 samples a user's voice using the voice recognition detector, the user can be identified and her User ID can be entered into the tablet device 220 and its UV agent 222. As discussed earlier, linking the user's voice to the User ID can be done through a lookup operation, which can be performed locally or remotely. Voice recognition can be performed using any number of methods that are capable of identifying a specific voice.

In other examples, the user can be identified through any other sensors/detectors (e.g., retina scanner) or any combinations thereof. These sensing/detection results can be used to identify the users.

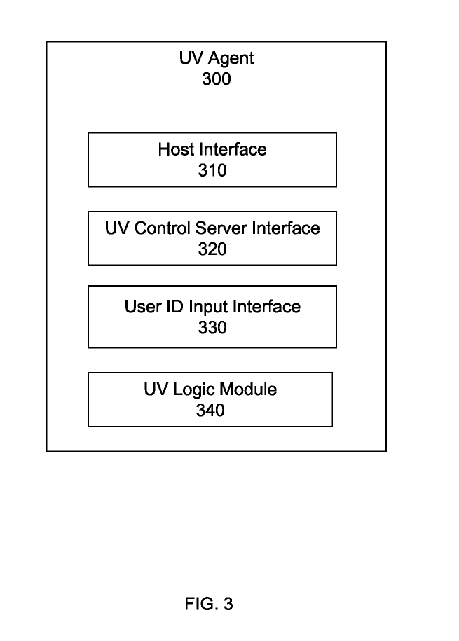

FIG. 3 illustrates a block diagram of an exemplary UV agent 300 in a UV system. A UV agent 300 can include a host interface 310, a UV control server interface 320, a User ID input interface 330, and a UV logic module 340. The agent 300 can communicate with its associated host (e.g., a UV client device 220) through the host interface 310. The agent 300 can communicate with the UV control server 240 through the UV control server interface 320. The agent 300 can communicate with the User ID input device 250 through the User ID input interface 330. The UV logic module 340 can provide application logic and execution of user virtualization on the UV client device 220. In one example, the UV logic module 340 can interpret the user virtualization information deployed by the UV control server 240 and apply it onto the UV client device 220. In another example, the UV logic module 340 can monitor a user's customization to her user virtualization information and upload it onto the UV control server 240. Examples of user virtualization information include: username and password, email account settings, downloaded files, application files and settings, and VPN or other security certificate installations, etc. User virtualization (UV) information will be discussed in details later.

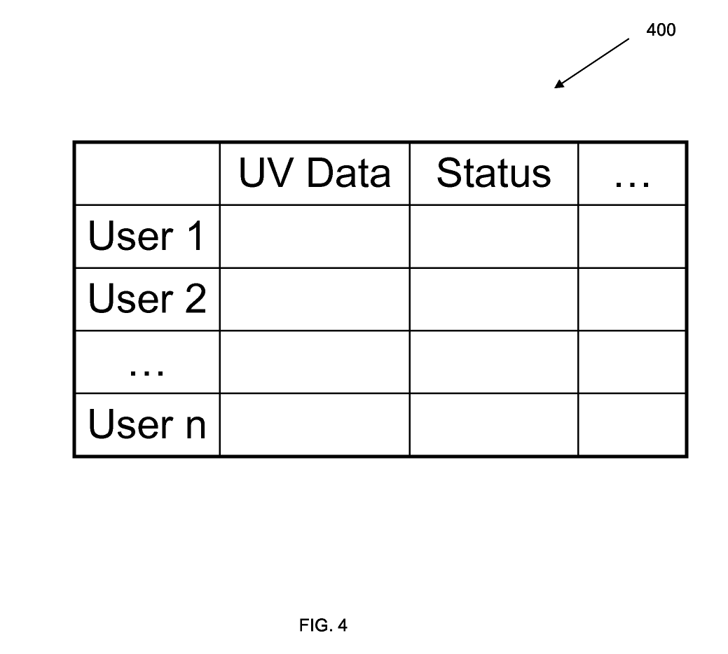

A UV system 200 can be managed by a UV control server 240. A UV control server 240 can store and maintain a UV control table that helps managing a UV system 200. FIG. 4 illustrates an exemplary UV control table 400 in a UV system 200. The UV control table 400 can contain the user virtualization information for the users (e.g., User 1-n) in the UV system 200. The UV control table 400 can be updated manually or automatically when a user of the UV system 200 is added/removed/modified. For each user in the UV control table 400, the UV control table 400 can include a UV data field and a status field, and/or other additional information. The UV data field can contain the actual UV information, a link to a logical/physical location where the UV information is stored (e.g., an external storage), or both. Some examples of UV information include: personalized settings, permitted applications, authorized access levels and privileges, customized background images, assigned ringtones, default network connection profiles, preferred payment information, etc. The UV information of a particular user can be set to default information defined by a system policy of the UV system 200; it can also be customized by the user, subject to any restrictions imposed by the system policy of the UV system 200. The status field can contain status information for a user of the UV system 200. Some examples of status information include: whether the user is currently logged in, whether any customization has been done, etc

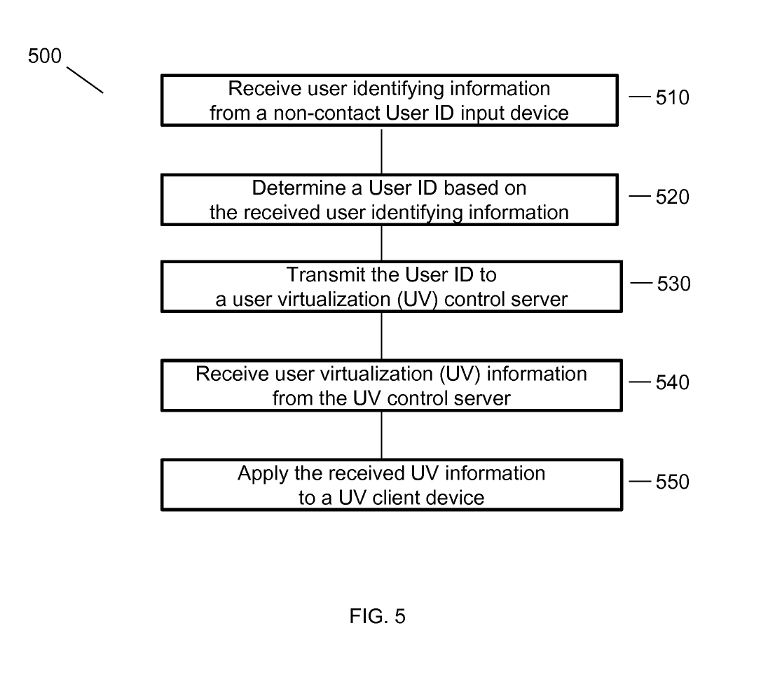

FIG. 5 illustrates an exemplary operation 500 of an UV system 200. At 510, a UV client device 220 receives user identifying information from a non-contact User ID input device (e.g., via the User ID input interface 330). For example, the UV client device 220 can scan the facial features of a user using a camera. The facial features of a user can uniquely identify the user and thus can contain or link to User ID information. At 520, the UV client device 220 can determine a User ID based on the received user identifying information. For example, a database of facial features can reside locally on the UV client device 220, or remotely on the UV control server 240 or other networked device (e.g., server 104 or storage 108/110/112). The UV client device 220 can access the facial features database and determines the User ID of the user from the scanned facial features of the user. At 530, the UV client device 220 can transmit the User ID to a UV control server 240 over the network 230 (e.g., via the UV control server interface 320). The UV control server 240 can receive the User ID, access the UV control table 400 to retrieve the corresponding UV information, and send the UV information back to the UV client device 220. Alternatively, if the User ID lookup has been performed on the UV control server 240, the UV client device 220 does not need to transmit the identified User ID to the UV control server 240. At 540, the UV client device 220 can receive the UV information from the UV control server 240 (e.g., via the UV control server interface 320). At 550, the UV client device 220 can interpret the received UV information (e.g., via the UV logic module 340) and apply it to the UV client device (e.g., via the host interface 310).

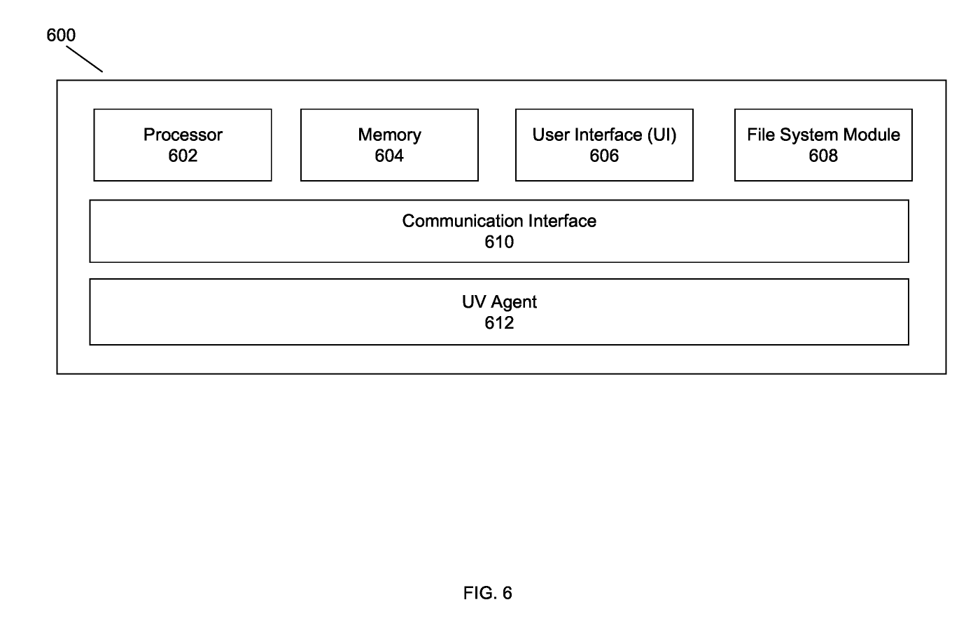

FIG. 6 illustrates a block diagram of a computing system that can be used to implement one or more aspects of the functionality described herein. The computing system 600 can serve as, for example, a client 106, a server 104, or both in the networked communication arrangement 100. The computing system 600 can also serve as, for example, a PC 210, a UV client device 220, a UV control server 240, or any combinations of them in the UV system 200. The computing system 600 can include at least one processor 602 and at least one memory 604. The processor 602 can be hardware that is configured to execute computer readable instructions such as software. The processor 602 can be a general processor or be an application specific hardware (e.g., an application specific integrated circuit (ASIC), programmable logic array (PLA), field programmable gate array (FPGA), or any other integrated circuit). The processor 602 can execute computer instructions or computer code to perform desired tasks. The memory 604 can be a transitory or non-transitory computer readable medium, such as flash memory, a magnetic disk drive, an optical drive, a programmable read-only memory (PROM), a read-only memory (ROM), or any other memory or combination of memories.

The computing system 600 can also optionally include a user interface (UI) 606, a file system module 608, and a communication interface 610. The UI 606 can provide an interface for users to interact with the computing system 600 in order to access the UV system 200. The file system module 608 can be configured to maintain a list of all data files, including both local data files and remote data files, in every folder in a file system. The file system module 608 can be further configured to coordinate with the memory 604 to store and cache files/data. The communication interface 610 can allow the computing system 600 to communicate with external resources (e.g., a network or a remote client/server). The computing system 600 can also include a UV agent 612. The description of the UV agent 612 and its functionalities can be found in the discussion of FIGS. 2-5. The computer system 600 can include additional modules, fewer modules, or any other suitable combination of modules that perform any suitable operation or combination of operations.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions.

What is claimed is:

1. A non-transitory computer readable medium having executable instructions operable to, when executed by a computing device, cause the computing device to:
acquire an input related to user identification (ID) information from a non-contact user ID input device;
determine a user ID based on the acquired input;
transmit the user ID to a UV control server over a network;
receive UV information corresponding to the user ID from the UV control server; and
apply the received UV information to a UV client device.

2. The non-transitory computer readable medium of claim 1, wherein the executable instructions are further operable to cause the computing device to acquire the input related to the user ID information from a Quick Reference (QR) code reader.

3. The non-transitory computer readable medium of claim 1, wherein the executable instructions are further operable to cause the computing device to acquire the input related to the user ID information from a Radio Frequency Identification (RFID) receiver.

4. The non-transitory computer readable medium of claim 1, wherein the executable instructions are further operable to cause the computing device to acquire the input related to the user ID information from a Near Field Communication (NFC) receiver.

5. The non-transitory computer readable medium of claim 1, wherein the executable instructions are further operable to cause the computing device to acquire the input related to the user ID information from a facial recognition detector.

6. The non-transitory computer readable medium of claim 1, wherein the executable instructions are further operable to cause the computing device to acquire the input related to the user ID information from a voice recognition detector.

7. The non-transitory computer readable medium of claim 1, wherein the executable instructions are further operable to cause the computing device to monitor customization of UV information and uploading the customization of UV information to the UV control server.

8. A user virtualization (UV) agent, comprising:
a host interface configured to communicate with a UV client device associated with the UV agent;
a UV control server interface configured to communicate with a UV control server over a network;
a user identification (ID) input interface configured to acquire an input related to user ID information from a non-contact user ID input device and determine a corresponding user ID using the acquired input; and
a UV logic module configured to interpret UV information received from the UV control server based on the user ID and apply the UV information to the UV client device.

9. The UV agent of claim 8, wherein the non-contact user ID input device includes a Quick Reference (QR) code reader.

10. The UV agent of claim 8, wherein the non-contact user ID input device includes a Radio Frequency Identification (RFID) receiver.

11. The UV agent of claim 8, wherein the non-contact user ID input device includes a Near Field Communication (NFC) receiver.

12. The UV agent of claim 8, wherein the non-contact user ID input device includes a facial recognition detector.

13. The UV agent of claim 8, wherein the non-contact user ID input device includes a voice recognition detector.

14. The UV agent of claim 8, wherein the UV logic module is further configured to monitor customization of UV information and upload the customization of UV information to the UV control server.
